(19) United States
(12) Patent Application Publication
(10) Pub. No.: US 2010/0319545 A1
(43) Pub. Date: Dec. 23, 2010

(54) CHARGED PARTICLE SEPARATION APPARATUS AND CHARGED PARTICLE BOMBARDMENT APPARATUS

(75) Inventors: MASAKI NARUSHIMA, Nirasaki-Shi (JP); Koichi Mori, Tokyo (JP); Isao Yamada, Kobe-Shi (JP); Noriaki Toyoda, Kobe-Shi (JP)

Correspondence Address: IPUSA, P.L.L.C, 1054 31ST STREET, N.W., Suite 400, Washington, DC, 20007, US

(73) Assignees: TOKYO ELECTRON LIMITED, Tokyo (JP); HYOGO PREFECTURE, Kobe-Shi (JP)

(21) Appl. No.: 12/818,758

(22) Filed: Jun. 18, 2010

(30) Foreign Application Priority Data
Jun. 19, 2009 (JP) 2009-146765

(51) Int. Cl. B03C 3/68; B03C 3/38

(52) U.S. Cl. 96/23; 96/54; 96/64

(57) ABSTRACT

A charged particle separation apparatus that separates ionized gas clusters is disclosed. The charged particle separation apparatus includes three or more electric field applying parts arranged in an incident direction of an ionized gas cluster, wherein each of the electric field applying parts includes a pair of electrodes; an electric power source configured to supply alternating-current electric voltages to the three or more electric field applying parts in such a manner that an alternating-current electric voltage applied across one pair of the electrodes of one of the three or more electric field applying parts is different in phase from an alternating-current voltage applied across another pair of the electrodes of an adjacent one of the three or more electric field applying parts; and a plate including an opening in an extension of the incident direction.

### CROSS-REFERENCE TO RELATED APPLICATION

The present application contains subject matter related to Japanese Patent Application No. 2009-146765 filed with the Japanese Patent Office on Jun. 19, 2009, the entire contents of which are incorporated herein by reference.

### BACKGROUND OF THE INVENTION

1. Field of the Invention

The present invention relates to a charged particle separation apparatus and a charged particle bombardment apparatus.

2. Description of the Related Art

Gas clusters into which plural atoms and the like are condensed exhibit unique physicochemical behavior, and attract attention for applications in various fields of technologies. Namely, gas cluster ion beams are thought to be applicable for processes such as ion-implantation, surface machining, and thin film deposition in a depth range of several nanometers from a surface of a solid material, while the processes in such a depth range have been considered difficult by conventional technologies.

In a gas cluster generating apparatus, it is possible to generate gas clusters formed of from several hundred through several thousand atoms from a compressed gas supplied from a gas supplying source. The number of the atoms in the gas cluster generated in the gas cluster generating apparatus may be stochastically-distributed, and masses of the gas cluster vary in a certain range. Therefore, the gas clusters need to be separated depending on the masses of the gas clusters.

To this end, a method has been proposed in order to separate the gas clusters generated by the gas cluster generating apparatus depending on the masses (Patent Document 1).

Patent Document 1: Japanese Patent Application Laid-Open Publication No. 2005-71642.

However, the ion clusters need to be separated depending on not only the masses but also valence numbers of the ion clusters. This is because intended use of the ion clusters greatly depends on the valence numbers, and more efficient and precise machining or the like can be realized when ion clusters having a desired valence number are separately used. According to experimental results obtained by the inventors of the inventions of the present application, ions can be traced even in a relatively deep area of a sample subject to ion cluster bombardment, which is deeper than a limited superficial layer of the sample.

The present invention has been made in view of the above, and provides a charged particle separation apparatus and a charged particle bombardment apparatus that are capable of separating ionized gas clusters depending on a valence number of the ionized gas clusters.

### SUMMARY OF THE INVENTION

A first aspect of the present invention provides a charged particle separation apparatus that separates ionized gas clusters. The charged particle separation apparatus includes three or more electric field applying parts arranged in an incident direction of an ionized gas cluster, wherein each of the electric field applying parts includes a pair of electrodes; an electric power source configured to supply alternating-current electric voltages to the three or more electric field applying parts in such a manner that an alternating-current electric voltage applied across one pair of the electrodes of one of the three or more electric field applying parts is different in phase from an alternating-current voltage applied across another pair of the electrodes of an adjacent one of the three or more electric field applying parts; and a plate including an opening in an extension of the incident direction.

A second aspect of the present invention provides a charged particle separation apparatus that separates ionized gas clusters. The charged particle separation apparatus includes three or more electric field applying parts arranged in an incident direction of an ionized gas cluster, wherein each of the electric field applying parts includes a pair of electrodes; an electric power source configured to supply alternating-current electric voltages to the three or more electric field applying parts in such a manner that an alternating-current electric voltage applied across one pair of the electrodes of one of the three or more electric field applying parts is different in phase from an alternating-current voltage applied across another pair of the electrodes of an adjacent one of the three or more electric field applying parts; and a plate including an opening through which an ionized gas cluster whose trajectory is deflected by the three or more electric field applying parts can pass.

A third aspect of the present invention provides a charged particle separation apparatus that separates ionized gas clusters. The charged particle separation apparatus includes three or more electric field applying parts arranged in an incident direction of an ionized gas cluster, wherein each of the electric field applying parts includes a pair of electrodes; an electric power source configured to supply alternating-current electric voltages superposed with a direct-current voltage to the three or more electric field applying parts in such a manner that a superposed electric voltage applied across one pair of the electrodes of one of the three or more electric field applying parts is different in phase from a superposed voltage applied across another pair of the electrodes of an adjacent one of the three or more electric field applying parts; and a plate including an opening through which an ionized gas cluster whose trajectory is deflected by the three or more electric field applying parts can pass.

A fourth aspect of the present invention provides a charged particle separation apparatus according to any one of the first through the third aspects, wherein a frequency of the alternating-current voltage is determined so that the ionized gas cluster having a predetermined valence number among ionized gas clusters having the same number of atoms can pass through the opening of the plate.

A fifth aspect of the present invention provides a charged particle separation apparatus according to the fourth aspect, wherein the predetermined valence number is 1.

A sixth aspect of the present invention provides a charged particle separation apparatus according to any one of the first through the fourth aspects, wherein the difference in phase is 180°.

A seventh aspect of the present invention provides a charged particle separation apparatus according to any one of the first through the sixth aspect, wherein the number of the three or more electric field applying parts is one of three and four.

An eighth aspect of the present invention provides charged particle bombardment apparatus including a gas cluster generation part that generates a gas cluster; an ionizing electrode that ionizes the gas cluster generated by the gas cluster generation part; acceleration electrodes that accelerate the ionized gas cluster; a charged particle separation apparatus according to any one of the first through the seventh aspects that separates an ionized gas cluster having a desired valence number among the ionized gas clusters accelerated by the acceleration electrodes, wherein the ionized gas cluster emitted from the charged particle separation apparatus is bombarded onto an object.

According to an embodiment of the present invention, a charged particle separation apparatus and a charged particle bombardment apparatus that are capable of separating ionized gas clusters depending on a valence number of the ionized gas clusters are provided.

### BRIEF DESCRIPTION OF THE DRAWINGS

FIG. 1 is a schematic view of a charged particle bombardment apparatus according to an embodiment of the present invention;

FIG. 2 is a schematic view of a charged particle separation apparatus according to a first embodiment of the present invention;

FIG. 3 illustrates a relationship between a deflection angle of ionized gas clusters and θ₁ when the charged particle separation apparatus is provided with one electric field applying part;

FIG. 4 illustrates a relationship between a deflection angle of ionized gas clusters and θ₁ when the charged particle separation apparatus is provided with two electric field applying parts;

FIG. 5 illustrates a relationship between a deflection angle of ionized gas clusters and θ₁ when the charged particle separation apparatus is provided with three electric field applying parts;

FIG. 6 is a schematic view of a charged particle separation apparatus according to a second embodiment of the present invention;

FIG. 7 is a schematic view of a charged particle separation apparatus according to a third embodiment of the present invention;

FIG. 8 illustrates a relationship between a deflection angle of ionized gas clusters and θ₁ when the charged particle separation apparatus is provided with four electric field applying parts;

FIG. 9 is a schematic view of a charged particle separation apparatus according to a fourth embodiment of the present invention;

FIG. 10 is a schematic view of a charged particle separation apparatus according to a fifth embodiment of the present invention;

FIG. 11 is a schematic view of a charged particle separation apparatus according to a sixth embodiment of the present invention;

FIG. 12 is a schematic view of a charged particle separation apparatus according to a seventh embodiment of the present invention; and

FIG. 13 is a schematic view of a charged particle separation apparatus according to an eighth embodiment of the present invention.

### DETAILED DESCRIPTION OF THE PREFERRED EMBODIMENT

Non-limiting, exemplary embodiments of the present invention will now be described with reference to the accompanying drawings. In the drawings, the same or corresponding reference symbols are given to the same or corresponding members or components.

### First Embodiment

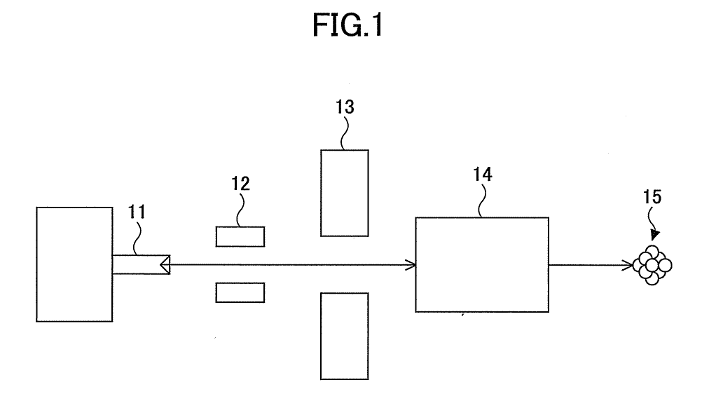

Referring to FIG. 1, a charged particle bombardment apparatus according to a first embodiment of the present invention is explained in the following. A charged particle bombardment apparatus according to this embodiment includes a nozzle part 11, ionization electrodes 12, acceleration electrodes 13, and a gas cluster separating part that corresponds to a charged particle separation apparatus according to this embodiment.

The nozzle part 11 generates gas clusters from pressurized gas. Specifically, gas supplied at a high pressure to the nozzle part 11 is jetted out from the nozzle part 11, and thus the gas clusters are generated. The gas used is a substance in gas phase at normal temperatures, and is preferably argon gas, oxygen gas, or the like.

By supplying, for example, argon gas, the argon gas clusters are generated. These gas clusters do not have the same number of argon atoms, but have various numbers of the argon atoms.

The generated gas clusters are ionized by the ionization electrodes 12, and thus ionized gas clusters are generated. The ionized gas clusters do not have a constant valence number, but may be univalent, divalent, trivalent, or the like.

Next, the ionized gas clusters are accelerated by the acceleration electrodes 13. At this time, the ionized gas cluster is accelerated inversely proportional to a square root of the number of the atoms constituting the gas cluster or a square root of a mass of the gas cluster. In addition, the gas cluster is accelerated proportional to a square root of the valence number of the ionization.

Next, the gas clusters are separated depending on the valence number of the gas clusters by the gas cluster separating part 14. In this embodiment, only a univalent ionized gas cluster 15 can be separated.

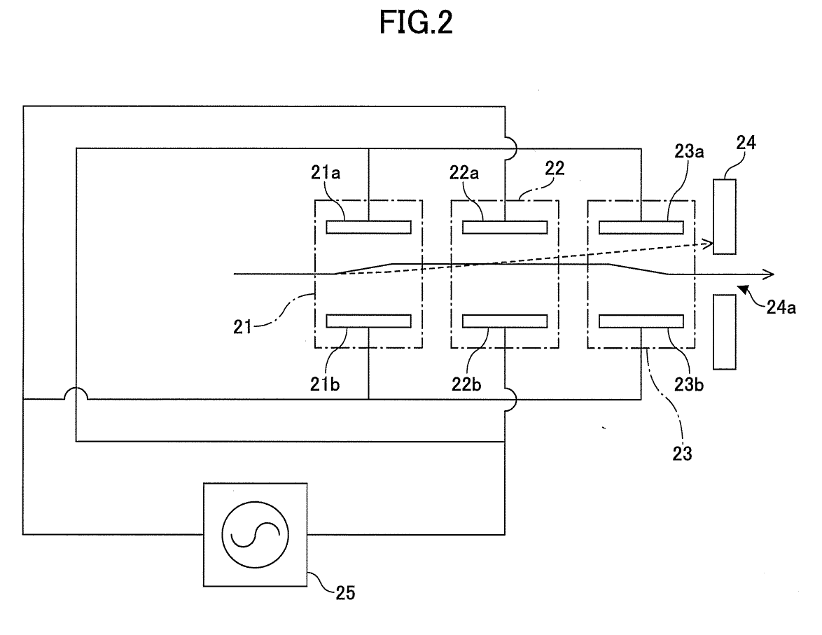

The gas cluster separating part 14 is explained, with reference to FIG. 2, which schematically illustrates the gas cluster separating part 14.

The gas cluster separating part 14 in this embodiment includes electric field applying parts 21, 22, 23, a plate 24, and an electric power source 25.

The electric field applying part 21 includes electrodes 21a, 21b. When an electric voltage is applied across the electrodes 21a, 21b, an electric field is generated between the electrodes 21a, 21b. The electric field applying part 22 includes electrodes 22a, 22b. When an electric voltage is applied across the electrodes 22a, 22b, an electric field is generated between the electrodes 22a, 22b. The electric field applying part 23 includes electrodes 23a, 23b. When an electric voltage is applied across the electrodes 23a, 23b, an electric field is generated between the electrodes 23a, 23b.

Alternating-current voltage is supplied from the electric power source 25 to the electric field applying parts 21, 22, 23. The electrodes 21b, 22a, and 23b are electrically connected, and the electrodes 21a, 22b, and 23a are electrically connected. The electric power source 25 applies electric potential at the electrodes 21a, 22b, 23a opposite in phase or 180° phase-shifted in relation to the electric potential applied at the electrodes 21b, 22a, 23b. A frequency and voltage value of the voltage supplied to the electric field applying parts 21, 22, 23 can be adjusted.

In addition, the plate 24 has an opening 24a through which the ionized gas clusters that have proceeded straight, among the ionized gas clusters that have passed through the electric field applying parts 21, 22, 23, can pass. Because an ionized gas cluster whose trajectory is deviated by the electric field applying parts 21, 22, 23 as shown by a dashed arrow in FIG. 2 cannot pass through the opening 24a of the plate 24, the ionized gas clusters can be separated. Namely, the ionized gas cluster proceeding straight as shown by a solid arrow in FIG. 2 can be separated by the gas cluster separation part 14.

In this embodiment, an alternating-current voltage having a predetermined frequency is applied across the electrodes 21a, 22b, 23a and the electrodes 21b, 22a, 23b, thereby separating the ionized gas clusters having a predetermined valence number.

(Ion Gas Cluster Trajectory Deviation)

Next, how a trajectory of the ionized gas cluster is deviated is explained.

Specifically, a deflection angle of an ion gas cluster and θ₁ defined by the following expression (1) are explained.

θ₁=ωl/v₀ (1)
where ω is an angular frequency of the voltage supplied from the electric power source 25, while a frequency of the voltage is defined by

f=ω/2π (2),
l is a length of a deflection system, namely a length of the electrodes in total along the moving direction of the ion gas clusters, and
v₀ is a speed of the ion gas cluster.

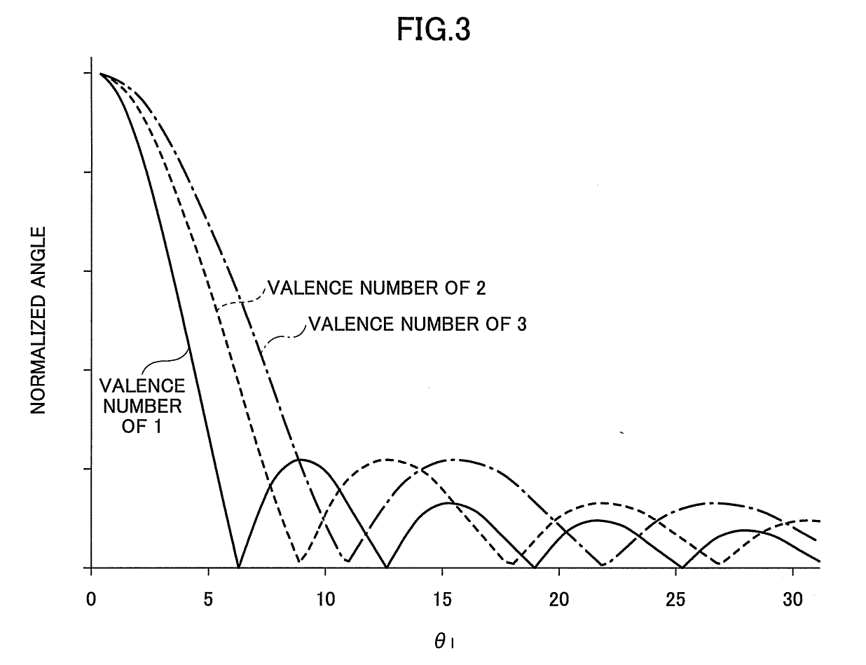

FIGS. 3 through 5 illustrate a relationship between the deflection angles of the ion clusters and θ₁ when one electric field applying part, two electric field applying parts, and three electric field applying parts are provided, respectively. Incidentally, 1 is 0.1 m; a cluster size of the ion gas cluster concerned is 1000 atoms per ion gas cluster; and an acceleration voltage for the ion gas cluster is 10 kV. The gas clusters are formed of argon atoms.

Referring to FIG. 3, the deflection angles of the ionized gas clusters are different depending on the valence number of 1, 2, or 3 in the case of one electric field applying part. However, a range of θ₁ where a deflection angle is stabilized is very limited, regardless of the valence number. Therefore, it is rather difficult to separate the ionized gas clusters having the corresponding valence numbers of 1, 2 or 3 by adjusting the frequency of the voltage supplied to the electric field applying part.

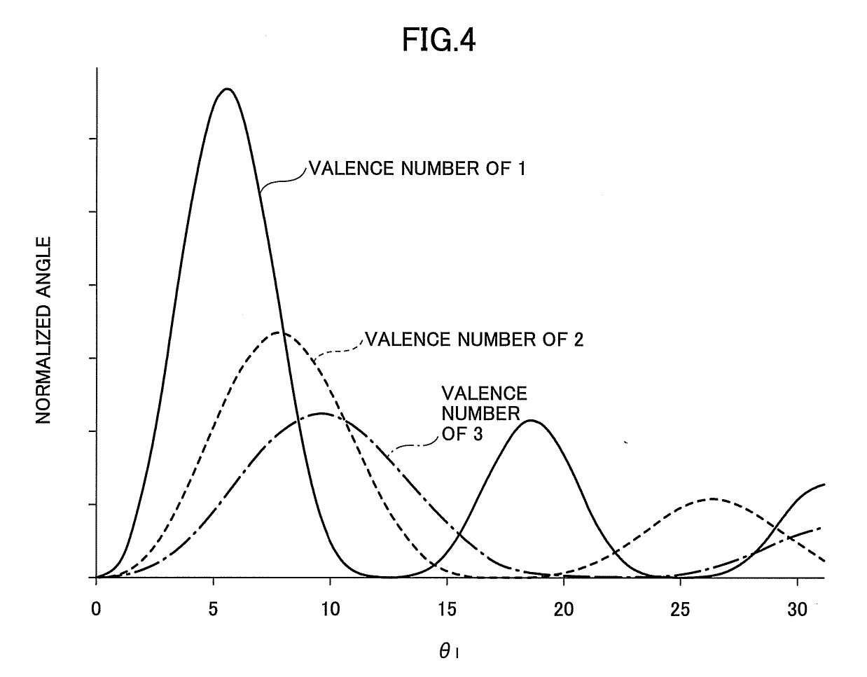

Referring to FIG. 4, the deflection angles of the ionized gas clusters are different depending on the valence numbers of 1, 2 or 3 in the case of two electric field applying parts, where the alternating-current voltages whose phases are opposite in phase or 180° shifted with each other are supplied to the two electric field applying parts, respectively. As shown, while there are certain ranges of θ₁ where the deflection angles are stabilized, these ranges are not overlapped. Therefore, it is rather difficult to separate the gas clusters depending on the valence numbers by changing the frequency.

Incidentally, while when θ₁ is about 12 to 13, namely when the frequency is about 130 to 140 kHz, the deflection angle of the gas cluster having the valence number of 1 is about zero, the deflection angles of the gas clusters having the valence numbers of 2 or 3 are not stabilized. In addition, there are ranges where the deflection angle of the gas clusters having the valence numbers of 2 or 3 is not very different from the deflection angle of the gas cluster having the valence number of 1. Namely, while the separation performance in the case of the two electric field applying parts is improved compared with the only one electric field applying part, it is still rather difficult in practical use.

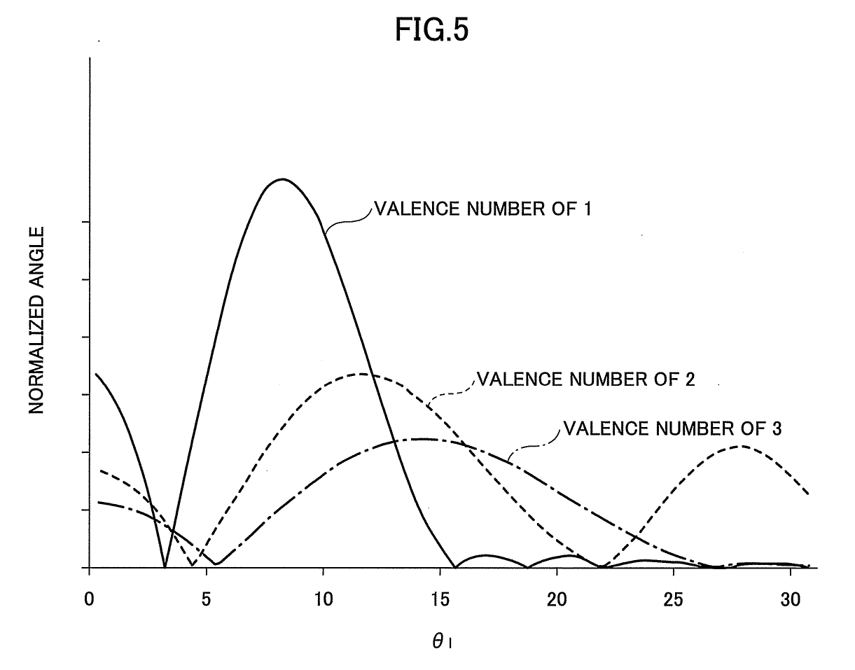

Referring to FIG. 5, the deflection angles of the ionized gas clusters are different depending on the valence numbers of 1, 2 or 3 in the case of three electric field applying parts, where the alternating-current voltages whose phases are opposite in phase or 180° shifted with one another are supplied to the three electric field applying parts, respectively. As shown, there are certain ranges of θ₁ where the deflection angles of the gas clusters having the valence numbers of 1, 2 or 3 are stabilized and overlapped with one another in the case of three electric field applying parts.

For example, when θ₁ is about 16, namely when the frequency is about 170 kHz, the deflection angle of the gas cluster having the valence number of 1 is about zero, and the deflection angles of the gas clusters having the valence numbers of 2 or 3 are relatively large, which makes it possible to substantially completely separate the gas clusters by use of the deflection angle of the gas cluster having the valence number of 1. Therefore, the separation performance is further improved in the case of the three electric field applying parts, compared to the one or two electric field applying parts, and the gas cluster separating part 14 (FIG. 1) having the three electric field applying parts is preferable in practical use.

As stated above, when the alternating-current voltage whose frequency is determined so that θ₁ is about 16 is applied by the electric power source 25, the gas cluster having the valence number of 1 can proceed straight, and the gas clusters having the valence numbers of 2 and 3 are deflected in this embodiment. With this, the gas cluster having the valence number of 1 can pass through the opening 24a of the plate 24 and the gas clusters having the valence numbers of 2 or 3 are blocked by the plate 24. Namely, the gas cluster having the valence number of 1 is selected.

Incidentally, while the above explanation is made about a case where the gas cluster having the valence number of 1 is separated, the gas cluster having the valence number of 2 or 3 can be separated, if necessary, by adjusting the frequency of the alternating-current voltage of the electric power source 25.

### Second Embodiment

Next, a second embodiment of the present invention is explained. A charged particle separation apparatus according to this embodiment includes three electric field applying parts, in the same manner as the first embodiment.

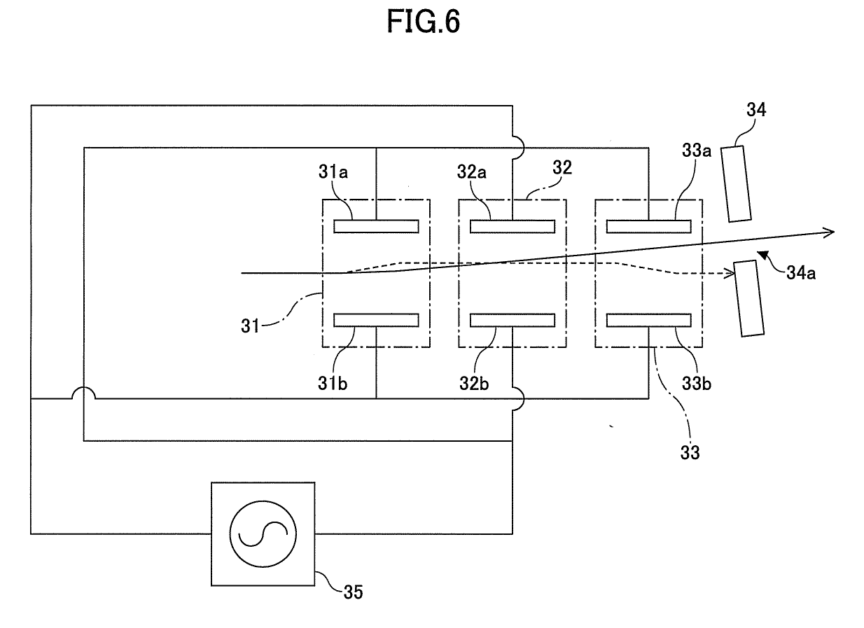

A cluster separation part in this embodiment is explained based on FIG. 6.

The gas cluster separation part in this embodiment includes three electric field applying parts 31, 32, 33, a plate 34, and an electric power source 35.

The electric field applying part 31 includes electrodes 31a, 31b. When an electric voltage is applied across the electrodes 31a, 31b, an electric field is generated between the electrodes 31a, 31b. The electric field applying part 32 includes electrodes 32a, 32b. When an electric voltage is applied across the electrodes 32a, 32b, an electric field is generated between the electrodes 32a, 32b. The electric field applying part 33 includes electrodes 33a, 33b. When an electric voltage is applied across the electrodes 33a, 33b, an electric field is generated between the electrodes 33a, 33b.

Alternating-current voltage is supplied from the electric power source 35 to the electric field applying parts 31, 32, 33. The electrodes 31a, 32b, and 33a are electrically connected, and the electrodes 31b, 32a and 33b are electrically connected. The electric power source 35 applies electric potential at the electrodes 31b, 32a, 33b opposite in phase or 180° phase-shifted in relation to the electric potential applied at the electrodes 31a, 32b, 33a. A frequency and voltage value of the voltage supplied to the electric field applying parts 31, 32, 33 can be adjusted by the electric power source 35.

The plate 34 is arranged so that the gas clusters whose trajectories are deflected at a predetermined deflection angle by the electric field applying parts 31, 32, 33, among gas clusters that have passed through the electric field applying parts 31, 32, 33, can pass through an opening 24a of the plate 24, while gas clusters whose trajectories are not deflected at a predetermined deflection angle by the electric field applying parts 31, 32, 33 cannot pass through the opening 34a. In other words, the gas clusters whose trajectories are deflected at the predetermined angle by the electric field applying parts 31, 32, 33 can be separated by the gas cluster separation part 14.

Namely, while the trajectories of the gas clusters having the valence numbers 2 or 3 are not deflected as much as possible, the trajectory of the gas cluster having the valence number of 1 is deflected at a large deflection angle by applying the alternating-current voltage from the electric power source 35 so that θ₁ become about 8, according to this embodiment. With this, when the plate 34 is arranged so that the gas cluster whose trajectory is deflected at a predetermined angle and is allowed to pass through the opening 34a of the silt 34, the gas cluster having the valence number of 1 can pass through the opening 34a and the gas clusters having the valence numbers of 2 or 3 are blocked by the plate 34. In addition, because the gas clusters moving straight cannot pass through the opening 34a of the plate 34, neutral gas clusters, which have not been ionized, are blocked by the plate 34. As a result, only the gas cluster having the valence number of 1 can be obtained.

Incidentally, while the above explanation is made about a case where the gas cluster having the valence number of 1 is separated, the gas cluster having the valence number of 2 or 3 can be separated, if necessary, by adjusting the frequency of the alternating-current voltage of the electric power source 35.

The second embodiment is substantially the same as the first embodiment of the present invention except for the configuration explained above. Therefore, the same charged particle bombardment apparatus as explained in the first embodiment can be obtained by employing the charged particle separation apparatus according to the second embodiment.

### Third Embodiment

Next, a third embodiment of the present invention is explained. A charged particle separation apparatus according to this embodiment includes four electric field applying parts, where the ionized gas cluster having the valence number of 1 is separated.

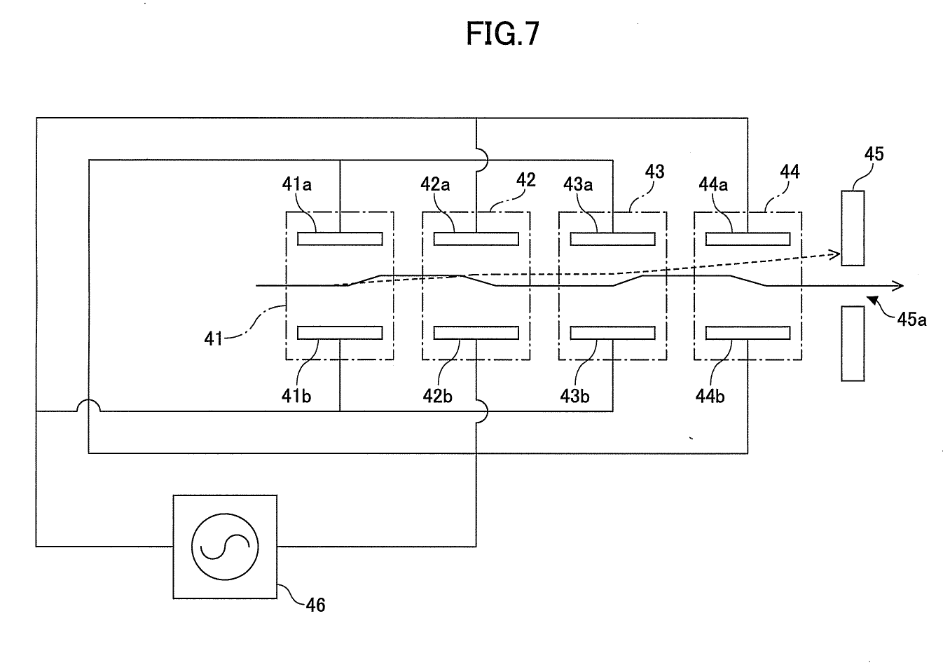

Referring to FIG. 7, a gas cluster separation part in this embodiment includes four electric field applying parts 41, 42, 43, 44, a plate 45, and an electric power source 46.

The electric field applying part 41 includes electrodes 41a, 41b. When an electric voltage is applied across the electrodes 41a, 41b, an electric field is generated between the electrodes 41a, 41b. The electric field applying part 42 includes electrodes 42a, 42b. When an electric voltage is applied across the electrodes 42a, 42b, an electric field is generated between the electrodes 42a, 42b. The electric field applying part 43 includes electrodes 43a, 43b. When an electric voltage is applied across the electrodes 43a, 43b, an electric field is generated between the electrodes 43a, 43b. The electric field applying part 44 includes electrodes 44a, 44b. When an electric voltage is applied across the electrodes 44a, 44b, an electric field is generated between the electrodes 44a, 44b.

Alternating-current voltage is supplied from the electric power source 46 to the electric field applying parts 41, 42, 43, 44. The electrodes 41a, 42b, 43a, and 44b are electrically connected, and the electrodes 41b, 42a, 43b, and 44a are electrically connected. The electric power source 46 applies electric potential at the electrodes 41b, 42a, 43b, 44a opposite in phase or 180° phase-shifted in relation to the electric potential applied at the electrodes 41a, 42b, 43a, and 44b. A frequency and voltage value of the voltage supplied to the electric field applying parts 41, 42, 43, 44 can be adjusted by the electric power source 46.

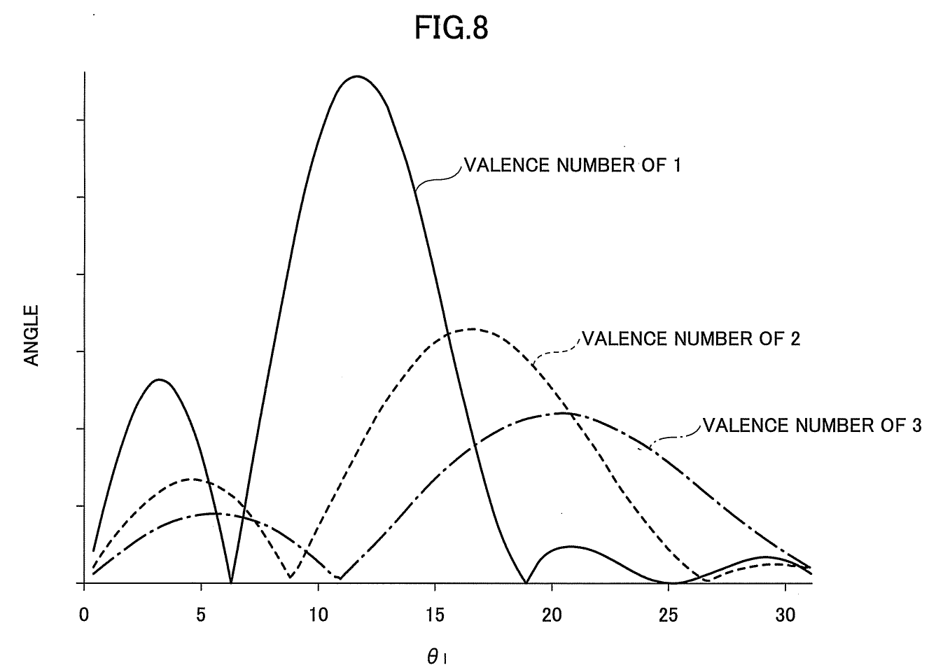

FIG. 8 illustrates a relationship between the deflection angle of the gas cluster and θ₁ in the case of the four electric field applying parts. Incidentally, l is 0.1 m; a cluster size of the ion gas cluster concerned is 1000 atoms per ion gas cluster; and an acceleration voltage for the ion gas cluster is 10 kV. The gas clusters are formed of argon atoms. In this embodiment, the alternating-current voltages opposite in phase are supplied to every two adjacent electric field applying parts.

In the case of the four electric field applying par, when θ₁ is about 18.5, namely when the frequency is about 200 kHz, the deflection angle of the gas cluster having the valence number of 1 is about zero, while the deflection angles of the gas clusters having the valence numbers of 2 or 3 are relatively large. Therefore, the gas cluster having the valence number of 1 can be separated. In addition, the separation performance of the ionized gas clusters is improved compared to a case where the three electric field applying parts are used.

This embodiment is based on the above considerations, and the gas cluster having the valence number of 1 is allowed to move straight, while the trajectories of the gas clusters having the valence numbers of 2 or 3 are deflected, by applying the alternating-current voltage having a frequency that makes θ₁ about 18.5 by the electric power source 45.

The plate 45 is arranged so that the gas clusters moving straight, among the gas clusters that have passed through the electric field applying parts 41, 42, 43, 44, can pass through the opening 45a of the plate 45. On the other hand, gas clusters whose trajectories are deflected at a predetermined deflection angle by the electric field applying parts 41, 42, 43, 44 cannot pass through the opening 45a. Namely, the gas clusters moving straight as shown by a solid arrow in FIG. 7 are allowed to pass through the opening 45a, while the gas clusters having the valence number of 2 or 3 whose trajectories are deflected as shown by a dashed arrow in FIG. 7 are blocked by the plate 45. Therefore, the gas cluster having the valence number of 1 can be separated by the gas cluster separation part 14.

Incidentally, while the above explanation is made about a case where the gas cluster having the valence number of 1 is separated, the gas cluster having the valence number of 2 or 3 can be separated, if necessary, by adjusting the frequency of the alternating-current voltage of the electric power source 46.

In addition, the third embodiment is substantially the same as the first embodiment of the present invention except for the configuration explained above. Therefore, the same charged particle bombardment apparatus as explained in the first embodiment can be obtained by employing the charged particle separation apparatus according to the third embodiment.

### Fourth Embodiment

Next, a fourth embodiment of the present invention is explained. A charged particle separation apparatus according to this embodiment includes four electric field applying parts, where the ionized gas cluster having the valence number of 1 is separated.

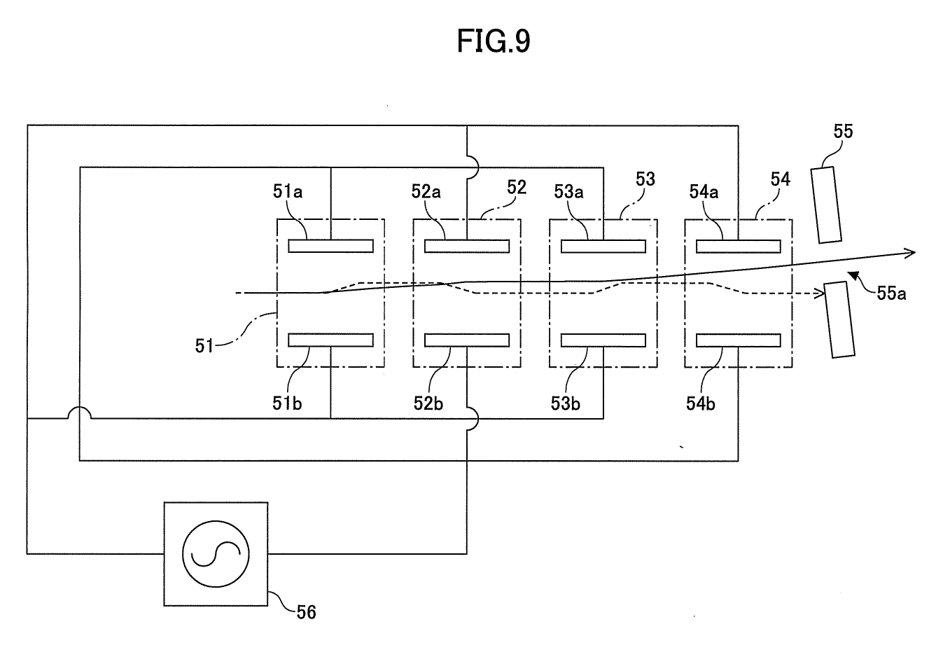

Referring to FIG. 9, a gas cluster separation part in this embodiment includes four electric field applying parts 51, 52, 53, 54, a plate 55, and an electric power source 56.

The electric field applying part 51 includes electrodes 51a, 51b. When an electric voltage is applied across the electrodes 51a, 51b, an electric field is generated between the electrodes 51a, 51b. The electric field applying part 52 includes electrodes 52a, 52b. When an electric voltage is applied across the electrodes 52a, 52b, an electric field is generated between the electrodes 52a, 52b. The electric field applying part 53 includes electrodes 53a, 53b. When an electric voltage is applied across the electrodes 53a, 53b, an electric field is generated between the electrodes 53a, 53b. The electric field applying part 54 includes electrodes 54a, 54b. When an electric voltage is applied across the electrodes 54a, 54b, an electric field is generated between the electrodes 54a, 54b.

Alternating-current voltage is supplied from the electric power source 56 to the electric field applying parts 51, 52, 53, 54. The electrodes 51a, 52b, 53a, 54b are electrically connected, and the electrodes 51b, 52a, 53b, 54a are electrically connected. The electric power source 56 applies electric potential at the electrodes 51b, 52a, 53b, 54a opposite in phase or 180° phase-shifted in relation to the electric potential applied at the electrodes 51a, 52b, 53a, 54b. A frequency and voltage value of the voltage supplied to the electric field applying parts 51, 52, 53, 54 can be adjusted by the electric power source 56.

The plate 55 is arranged so that the gas clusters whose trajectories are deflected at a predetermined angle, among the gas clusters that have passed through the electric field applying parts 51, 52, 53, 54, can pass through an opening 55a of the plate 55. On the other hand, gas clusters whose trajectories are not deflected at a predetermined deflection angle by the electric field applying parts 51, 52, 53, 54 cannot pass through the opening 55a. Therefore, the gas cluster whose trajectory is deflected at a predetermined angle can be separated by the gas cluster separation part 14.

Namely, the gas cluster having the valence number of 1 is deflected at a relatively large angle, while the gas clusters having the valence numbers of 2 or 3 are not deflected, by applying the alternating-current voltage having a frequency that makes θ₁ about 11.5 (see FIG. 8) by the electric power source 56. Therefore, when the plate 55 is arranged so that the gas cluster having the valence number of 1 whose trajectories are deflected at a predetermined relatively large deflection angle are allowed to pass through the opening 55a of the plate 55, the gas cluster having the valence number of 1 can pass through the opening 55a, while the gas clusters having the valence numbers of 2 or 3 are blocked by the plate 55. With this, the gas cluster having the valence number of 1 can be separated. In addition, because the gas clusters moving straight cannot pass through the opening 55a of the plate 55, neutral gas clusters can be blocked by the plate 55. Therefore, only the gas cluster having the valence number of 1 can be separated.

Incidentally, while the above explanation is made about a case where the gas cluster having the valence number of 1 is separated, the gas cluster having the valence number of 2 or 3 can be separated, if necessary, by adjusting the frequency of the alternating-current voltage of the electric power source 56.

The fourth embodiment is substantially the same as the first or the third embodiment of the present invention except for the configuration of the plate 55 and the frequency of the alternating-current voltage of the electric power source 56. Therefore, the same charged particle bombardment apparatus as explained in the first embodiment can be obtained by employing the charged particle separation apparatus according to the fourth embodiment.

As stated above, the ionized gas clusters can be efficiently separated depending on the valence number with the three or more electric field applying parts. In addition, the separation performance of the ionized gas clusters depending on the valence number can be improved by increasing the number of the electric field applying parts.

### Fifth Embodiment

Next, a fifth embodiment of the present invention is explained. A charged particle separation apparatus according to this embodiment includes an additional electric power source that outputs a direct-current voltage.

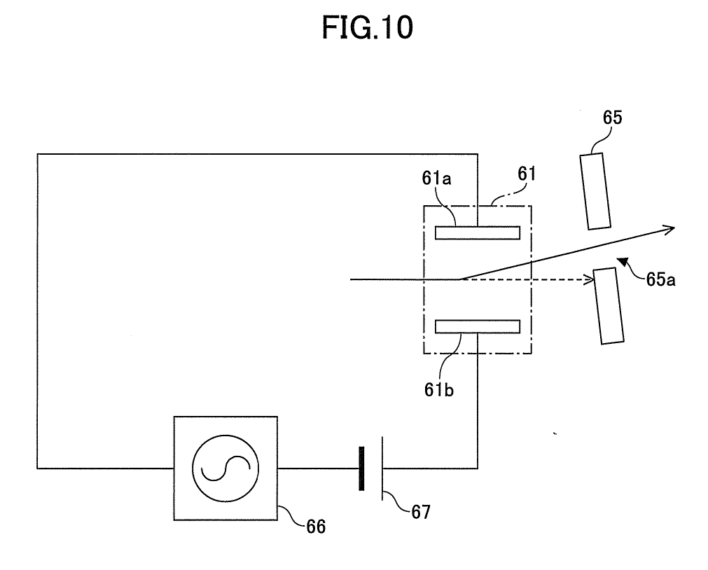

Referring to FIG. 10, the gas cluster separation part according to this embodiment includes an electric field applying part 61, a plate 66, an alternating-current power source 66, and a direct-current power source 67.

The electric field applying part 61 includes electrodes 61a, 61b. When an electric voltage is applied across the electrodes 61a, 61b, an electric field is generated between the electrodes 61a, 61b.

The electric voltage is applied by the alternating-current power source 66 and the direct-current power source 67. Namely, alternating-current voltage biased by (or superposed with) direct-current voltage is applied to the electrodes 61a, 61b. An electric potential at the electrode 61b is opposite in phase or 180° phase-shifted in relation to an electric potential at the electrode 61a. A frequency and voltage applied to the electrodes 61a, 61b can be adjusted by the alternating-current power source 66 and/or the direct-current power source 67.

In addition, the plate 65 is arranged so that the gas clusters whose trajectories are deflected by the electric field applying part 61, among gas clusters that have passed through the electric field applying part 61, can pass through an opening 65a of the plate 65. The gas clusters whose trajectories are not deflected by the electric field applying part 61 cannot pass through the opening 65a of the plate 65. Therefore, the gas clusters whose trajectories are deflected can be separated in the gas cluster separation part of this embodiment.

Namely, because the alternating-current voltage having a frequency that makes θ₁ about 6.3 (see FIG. 3), i.e., about 70 kHz, from the alternating-current power source 66 and the direct-current voltage from the direct-current power source 67 are superposed and supplied to the electric field applying part 61, the gas cluster having the valence number of 1 is deflected at a predetermined angle and is allowed to pass through the opening 65a of the plate 65, while neutral gas clusters are blocked by the plate 65. Therefore, only the gas cluster having the valence number of 1 can be separated, excluding the neutral gas clusters.

Incidentally, while the above explanation is made about a case where the gas cluster having the valence number of 1 is separated, the gas cluster having the valence number of 2 or 3 can be separated, if necessary, by adjusting the frequency of the alternating-current voltage of the alternating-current power source 66 and the direct-current power source 67.

The fifth embodiment is substantially the same as the first or the like except for the configuration explained above. Therefore, the same charged particle bombardment apparatus as explained in the first embodiment can be obtained by employing the charged particle separation apparatus according to the fifth embodiment.

### Sixth Embodiment

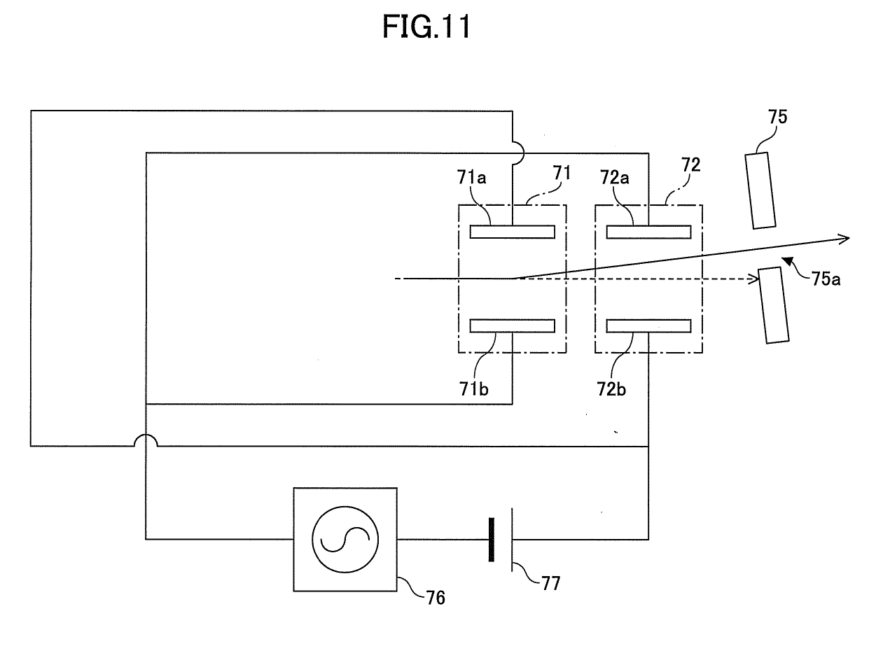

Next, a sixth embodiment of the present invention is explained with reference to FIG. 11. A charged particle separation apparatus according to this embodiment includes an additional electric power source that outputs a direct-current voltage.

The gas cluster separation part 14 according to this embodiment includes two electric field applying parts 71, 73, a plate 75, an alternating-current power source 76, and a direct-current power source 77.

The electric field applying part 71 includes electrodes 71a, 71b. When an electric voltage is applied across the electrodes 71a, 71b, an electric field is generated between the electrodes 71a, 71b. The electric field applying part 72 includes electrodes 72a, 72b. When an electric voltage is applied across the electrodes 72a, 72b, an electric field is generated between the electrodes 72a, 72b.

The electric voltage is supplied by the alternating-current power source 76 and the direct-current power source 77. Namely, alternating-current voltage biased by (or superposed with) direct-current voltage is supplied to the electric field applying parts 71, 72. The electrodes 71a, 72b are electrically connected, and the electrodes 71b, 72a are electrically connected. Electric potentials at the electrodes 71b, 72a are opposite in phase or 180° phase-shifted in relation to electric potentials at the electrodes 71a, 72b. A frequency and voltage supplied to the electric field applying parts 71, 72 can be adjusted by the alternating-current power source 76 and/or the direct-current power source 77.

The plate 75 is arranged so that the gas clusters whose trajectories are deflected at a predetermined angle, among gas clusters that has passed through the two electric field applying parts 71, 72, can pass through an opening 75a of the plate 75. On the other hand, the gas clusters whose trajectories are not deflected at a predetermined angle by the electric field applying parts 71, 72 cannot pass through the opening 75a. Therefore, only the gas clusters whose trajectories are deflected at a predetermined angle can be separated by the gas cluster separation part.

Namely, because the alternating-current voltage having a frequency that makes θ₁ about 12 through about 13 (see FIG. 4), i.e., about 130 through 140 kHz, from the alternating-current power source 76 and the direct-current voltage from the direct-current power source 77 are superposed and supplied to the electric field applying parts 71, 72, the gas cluster having the valence number of 1 is deflected at a predetermined angle and is allowed to pass through the opening 75a of the plate 75, while neutral gas clusters are blocked by the plate 75. Therefore, only the gas cluster having the valence number of 1 can be separated, excluding the neutral gas clusters.

Incidentally, while the above explanation is made about a case where the gas cluster having the valence number of 1 is separated, the gas cluster having the valence number of 2 or 3 can be separated, if necessary, by adjusting the frequency of the alternating-current voltage of the alternating-current power source 76 and the direct-current power source 77.

The sixth embodiment is substantially the same as the first or the like except for the configuration explained above. Therefore, the same charged particle bombardment apparatus as explained in the first embodiment can be obtained by employing the charged particle separation apparatus according to the sixth embodiment.

### Seventh Embodiment

Next, a seventh embodiment of the present invention is explained. A charged particle separation apparatus according to this embodiment includes an additional electric power source that outputs a direct-current voltage.

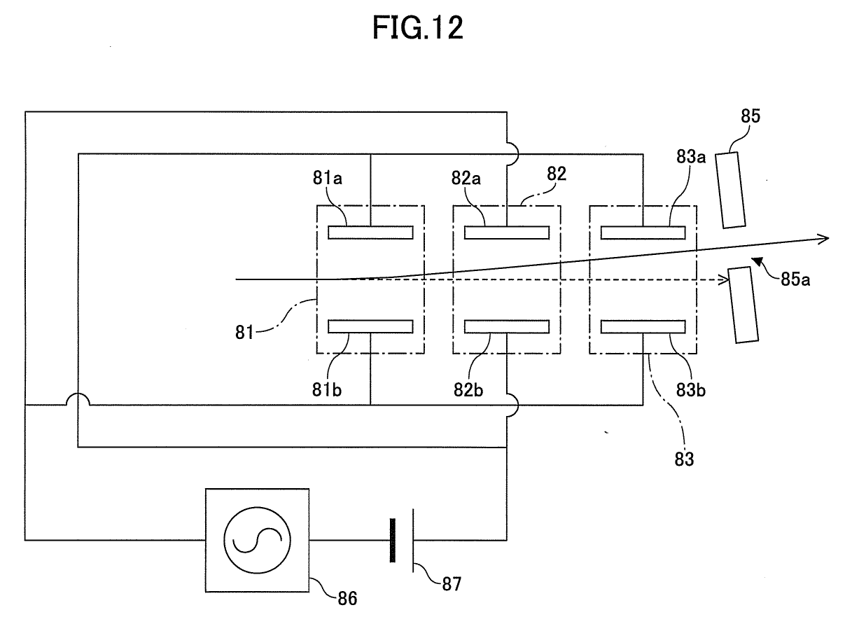

Referring to FIG. 12, a gas cluster separation part according to this embodiment includes three electric field applying parts 81, 82, 83, a plate 85, an alternating-current power source 86, and a direct-current power source 87.

The electric field applying part 81 includes electrodes 81a, 81b. When an electric voltage is applied across the electrodes 81a, 81b, an electric field is generated between the electrodes 81a, 81b. The electric field applying part 82 includes electrodes 82a, 82b. When an electric voltage is applied across the electrodes 82a, 82b, an electric field is generated between the electrodes 82a, 82b. The electric field applying part 83 includes electrodes 83a, 83b. When an electric voltage is applied across the electrodes 83a, 83b, an electric field is generated between the electrodes 83a, 83b.

The electric voltage is supplied by the alternating-current power source 86 and the direct-current power source 87. Namely, alternating-current voltage biased by (or superposed with) direct-current voltage is supplied to the electric field applying parts 81, 82. The electrodes 81a, 82b, 83a are electrically connected, and the electrodes 81b, 82a, 83b are electrically connected. Electric potentials at the electrodes 81b, 82a, 83b are opposite in phase or 180° phase-shifted in relation to electric potentials at the electrodes 81a, 82b, 83a. A frequency and voltage supplied to the electric field applying parts 81, 82, 83 can be adjusted by the alternating-current power source 86 and/or the direct-current power source 87.

The plate 85 is arranged so that the gas clusters whose trajectories are deflected at a predetermined angle, among gas clusters that has passed through the two electric field applying parts 81, 82, 83, can pass through an opening 85a of the plate 85. On the other hand, the gas clusters whose trajectories are not deflected at a predetermined angle by the electric field applying parts 81, 82, 83 cannot pass through the opening 75a. Therefore, only the gas clusters whose trajectories are deflected at a predetermined angle can be separated by the gas cluster separation part.

Namely, because the alternating-current voltage having a frequency that makes θ₁ about 16 (see FIG. 5), i.e., about 170 kHz, from the alternating-current power source 86 and the direct-current voltage from the direct-current power source 87 are superposed and supplied to the electric field applying parts 81, 82, 83, the gas cluster having the valence number of 1 is deflected at a predetermined angle and is allowed to pass through the opening 85a of the plate 85, while neutral gas clusters are blocked by the plate 85. Therefore, only the gas cluster having the valence number of 1 can be separated, excluding the neutral gas clusters.

Incidentally, while the above explanation is made about a case where the gas cluster having the valence number of 1 is separated, the gas cluster having the valence number of 2 or 3 can be separated, if necessary, by adjusting the frequency of the alternating-current voltage of the alternating-current power source 86 and the direct-current power source 87.

The seventh embodiment is substantially the same as the first or the like except for the configuration explained above. Therefore, the same charged particle bombardment apparatus as explained in the first embodiment can be obtained by employing the charged particle separation apparatus according to the seventh embodiment.

### Eighth Embodiment

Next, an eighth embodiment of the present invention is explained. A charged particle separation apparatus according to this embodiment includes an additional electric power source that outputs a direct-current voltage.

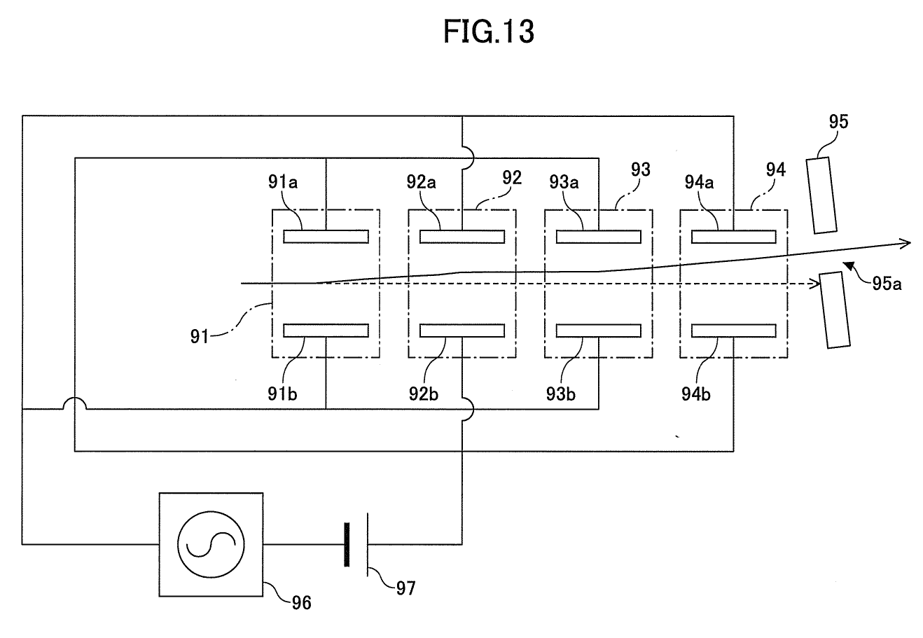

Referring to FIG. 13, a gas cluster separation part according to this embodiment includes four electric field applying parts 91, 92, 93, 94, a plate 95, an alternating-current power source 96, and a direct-current power source 97.

The electric field applying part 91 includes electrodes 91a, 91b. When an electric voltage is applied across the electrodes 91a, 91b, an electric field is generated between the electrodes 91a, 91b. The electric field applying part 92 includes electrodes 92a, 92b. When an electric voltage is applied across the electrodes 92a, 92b, an electric field is generated between the electrodes 92a, 92b. The electric field applying part 93 includes electrodes 93a, 93b. When an electric voltage is applied across the electrodes 93a, 93b, an electric field is generated between the electrodes 93a, 93b. The electric field applying part 94 includes electrodes 94a, 94b. When an electric voltage is applied across the electrodes 94a, 94b, an electric field is generated between the electrodes 94a, 94b.

The electric voltage is supplied by the alternating-current power source 96 and the direct-current power source 97. Namely, alternating-current voltage biased by (or superposed with) direct-current voltage is supplied to the electric field applying parts 91, 92. The electrodes 91a, 92b, 93a are electrically connected, and the electrodes 91b, 92a, 93b are electrically connected. Electric potentials at the electrodes 91b, 92a, 93b are opposite in phase or 180° phase-shifted in relation to electric potentials at the electrodes 91a, 92b, 93a. A frequency and voltage supplied to the electric field applying parts 91, 92, 93 can be adjusted by the alternating-current power source 96 and/or the direct-current power source 97.

The plate 95 is arranged so that the gas clusters whose trajectories are deflected at a predetermined angle, among gas clusters that has passed through the two electric field applying parts 91, 92, 93, 94, can pass through an opening 95a of the plate 95. On the other hand, the gas clusters whose trajectories are not deflected at a predetermined angle by the electric field applying parts 91, 92, 93, 94 cannot pass through the opening 95a. Therefore, only the gas clusters whose trajectories are deflected at a predetermined angle can be separated by the gas cluster separation part.

Namely, because the alternating-current voltage having a frequency that makes θ₁ about 18.5 (see FIG. 8), i.e., about 200 kHz, from the alternating-current power source 76 and the direct-current voltage from the direct-current power source 77 are superposed and supplied to the electric field applying parts 91, 92, 93, 94 the gas cluster having the valence number of 1 is deflected at a predetermined angle and is allowed to pass through the opening 95a of the plate 95, while neutral gas clusters are blocked by the plate 95. Therefore, only the gas cluster having the valence number of 1 can be separated, excluding the neutral gas clusters.

Incidentally, while the above explanation is made about a case where the gas cluster having the valence number of 1 is separated, the gas cluster having the valence number of 2 or 3 can be separated, if necessary, by adjusting the frequency of the alternating-current voltage of the alternating-current power source 96 and the direct-current power source 97.

The eighth embodiment is substantially the same as the first or the like except for the configuration explained above. Therefore, the same charged particle bombardment apparatus as explained in the first embodiment can be obtained by employing the charged particle separation apparatus according to the eighth embodiment.

Although several embodiments according to the present invention have been explained, the present invention is not limited to the foregoing embodiments, but may be modified or altered within the scope of the accompanying claims.

What is claimed is:

1. A charged particle separation apparatus that separates ionized gas clusters, the charged particle separation apparatus comprising:
three or more electric field applying parts arranged in an incident direction of an ionized gas cluster, wherein each of the electric field applying parts includes a pair of electrodes;
an electric power source configured to supply alternating-current electric voltages to the three or more electric field applying parts in such a manner that an alternating-current electric voltage applied across one pair of the electrodes of one of the three or more electric field applying parts is different in phase from an alternating-current voltage applied across another pair of the electrodes of an adjacent one of the three or more electric field applying parts; and
a plate including an opening in an extension of the incident direction.

2. A charged particle separation apparatus that separates ionized gas clusters, the charged particle separation apparatus comprising:
three or more electric field applying parts arranged in an incident direction of an ionized gas cluster, wherein each of the electric field applying parts includes a pair of electrodes;
an electric power source configured to supply alternating-current electric voltages to the three or more electric field applying parts in such a manner that an alternating-current electric voltage applied across one pair of the electrodes of one of the three or more electric field applying parts is different in phase from an alternating-current voltage applied across another pair of the electrodes of an adjacent one of the three or more electric field applying parts; and
a plate including an opening through which an ionized gas cluster whose trajectory is deflected by the three or more electric field applying parts can pass.

3. A charged particle separation apparatus that separates ionized gas clusters, the charged particle separation apparatus comprising:
three or more electric field applying parts arranged in an incident direction of an ionized gas cluster, wherein each of the electric field applying parts includes a pair of electrodes;
an electric power source configured to supply alternating-current electric voltages superposed with a direct-current voltage to the three or more electric field applying parts in such a manner that a superposed electric voltage applied across one pair of the electrodes of one of the three or more electric field applying parts is different in phase from a superposed voltage applied across another pair of the electrodes of an adjacent one of the three or more electric field applying parts; and
a plate including an opening through which an ionized gas cluster whose trajectory is deflected by the three or more electric field applying parts can pass.

4. The charged particle separation apparatus recited in claim 1, wherein a frequency of the alternating-current voltage is determined so that the ionized gas cluster having a predetermined valence number among ionized gas clusters having the same number of atoms can pass through the opening of the plate.

5. The charged particle separation apparatus recited in claim 2, wherein a frequency of the alternating-current voltage is determined so that the ionized gas cluster having a predetermined valence number among ionized gas clusters having the same number of atoms can pass through the opening of the plate.

6. The charged particle separation apparatus recited in claim 3, wherein a frequency of the alternating-current voltage is determined so that the ionized gas cluster having a predetermined valence number among ionized gas clusters having the same number of atoms can pass through the opening of the plate.

7. The charged particle separation apparatus recited in claim 4, wherein the predetermined valence number is 1.

8. The charged particle separation apparatus recited in claim 5, wherein the predetermined valence number is 1.

9. The charged particle separation apparatus recited in claim 6, wherein the predetermined valence number is 1.

10. The charged particle separation apparatus recited in claim 1, wherein the difference in phase is 180°.

11. The charged particle separation apparatus recited in claim 2, wherein the difference in phase is 180°.

12. The charged particle separation apparatus recited in claim 3, wherein the difference in phase is 180°.

13. The charged particle separation apparatus recited in claim 1, wherein the number of the three or more electric field applying parts is one of three and four.

14. The charged particle separation apparatus recited in claim 2, wherein the number of the three or more electric field applying parts is one of three and four.

15. The charged particle separation apparatus recited in claim 3, wherein the number of the three or more electric field applying parts is one of three and four.

16. A charged particle bombardment apparatus comprising:
a gas cluster generation part that generates a gas cluster;
an ionizing electrode that ionizes the gas cluster generated by the gas cluster generation part;
acceleration electrodes that accelerate the ionized gas cluster; and
a charged particle separation apparatus recited in claim 1 that separates an ionized gas cluster having a desired valence number among the ionized gas clusters accelerated by the acceleration electrodes,
wherein the ionized gas cluster emitted from the charged particle separation apparatus is bombarded onto an object.

17. A charged particle bombardment apparatus comprising:
a gas cluster generation part that generates a gas cluster;
an ionizing electrode that ionizes the gas cluster generated by the gas cluster generation part;
acceleration electrodes that accelerate the ionized gas cluster; and
a charged particle separation apparatus recited in claim 2 that separates an ionized gas cluster having a desired valence number among the ionized gas clusters accelerated by the acceleration electrodes,
wherein the ionized gas cluster emitted from the charged particle separation apparatus is bombarded onto an object.

18. A charged particle bombardment apparatus comprising:
a gas cluster generation part that generates a gas cluster;
an ionizing electrode that ionizes the gas cluster generated by the gas cluster generation part;
acceleration electrodes that accelerate the ionized gas cluster; and
a charged particle separation apparatus recited in claim 3 that separates an ionized gas cluster having a desired valence number among the ionized gas clusters accelerated by the acceleration electrodes,
wherein the ionized gas cluster emitted from the charged particle separation apparatus is bombarded onto an object.
